(19) United States
(12) Patent Application Publication
(10) Pub. No.: US 2014/0279627 A1
(43) Pub. Date: Sep. 18, 2014

(54) METHODS AND SYSTEMS FOR DETERMINING SKILLS OF AN EMPLOYEE

(71) Applicant: XEROX CORPORATION, Norwalk, CT (US)

(72) Inventors: Dhanwant S. Kang, Raleigh, NC (US); Hua Liu, Fairport, NY (US); Tong Sun, Penfield, NY (US); Saurabh Kataria, Jind (IN)

(73) Assignee: XEROX CORPORATION, Norwalk, CT (US)

(21) Appl. No.: 13/803,951

(22) Filed: Mar. 14, 2013

(51) Int. Cl. G06Q 10/10

(52) U.S. Cl. CPC G06Q 10/105
USPC 705/320

(57) ABSTRACT

A method, system, and computer program product for determining skills of an employee is disclosed. The method includes determining a first likelihood of at least one keyword from a plurality of keywords being relevant to a topic. The plurality of keywords is extractable from one or more publications associated with the employee, the one or more publications being accessible from a plurality of sources. The method further includes determining a second likelihood of the employee being associated with the topic for at least one source from the plurality of sources. A first set of keywords from the plurality of keywords is assigned to the employee based on the first likelihood and the second likelihood. The first set of keywords is indicative of the skills of the employee.

### TECHNICAL FIELD

The presently disclosed embodiments are related, in general, to data mining. More particularly, the presently disclosed embodiments are related to systems and methods for determining skills of an employee.

### BACKGROUND

An organization is a social unit of people or employees that is structured and managed to meet a need or pursue collective goals. In order to have a goal oriented workforce, the organization may evaluate the employees (constituting the work force) to determine skills of the employees.

In order to determine the skills of the employee, the organization may conduct interviews of the employee with managers, team leaders, or supervisors. Based on the interviews, the managers may fill up one or more documents such as, but are not limited to, surveys, and questionnaires about the employee. The one or more documents may indicate a skills set of the employee. Filling and collating the one or more documents for each of the one or more employees in the organization may be a cumbersome and time-consuming job for the managers. Further, the rapport of the employee with the manager (conducting the interview) may affect the skills set of the employee.

### SUMMARY

According to embodiments illustrated herein there is provided a method implementable on a computing device for determining skills of an employee. The method includes determining a first likelihood of at least one keyword from a plurality of keywords being relevant to a topic. The plurality of keywords is extractable from one or more publications associated with the employee, the one or more publications being accessible from a plurality of sources. The method further includes determining a second likelihood of the employee being associated with the topic for at least one source from the plurality of sources. A first set of keywords from the plurality of keywords is assigned to the employee based on the first likelihood and the second likelihood. The first set of keywords is indicative of the skills of the employee.

According to embodiments illustrated herein there is provided a data mining server for determining skills of an employee. The data mining server includes a keyword extractor configured to extract a plurality of keywords from one or more publications associated with the employee. The one or more publications are accessible from a plurality of sources. Further, the data mining server includes a probability determination module configured to determine a first likelihood of at least one keyword from a plurality of keywords being relevant to a topic. Further, the probability determination module is configured to determine a second likelihood of the employee being associated with the topic for at least one source from the plurality of sources. A skills determination module configured to assign a first set of keywords from the plurality of keywords to the employee based on the first likelihood and the second likelihood. The first set of keywords is indicative of the skills of the employee.

According to embodiments illustrated herein there is provided a computer program product for determining skills of an employee. The computer program product comprising a set of instructions executable by a processor. The set of instructions comprising a program instruction means for extracting a plurality of keywords from one or more publications associated with the employee. The one or more publications are accessible from a plurality of sources. The set of instructions further includes a program instruction means for determining a first likelihood of at least one keyword from a plurality of keywords being relevant to a topic. Additionally, the set of instructions includes a program instruction means for determining a second likelihood of the employee being associated with the topic for at least one source from the plurality of sources. A program instruction means for assigning a first set of keywords from the plurality of keywords to the employee based on the first likelihood and the second likelihood. The first set of keywords is indicative of the skills of the employee.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

FIG. 1 is a block diagram of a system environment in which various embodiments can be implemented;

FIG. 2 is a block diagram of a system for determining skills of an employee, in accordance with at least one embodiment;

FIG. 3 is a flowchart illustrating a method for determining skills of an employee, in accordance with at least one embodiment; and

FIG. 4 is a table illustrating sample skills of an employee, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Skills” refers to one or more abilities of an employee. In an embodiment, the employee may utilize the one or more abilities to complete a task. In an embodiment, the skills of an employee may be classified as, but not limited to, a managerial skills, engineering skills, and research skills.

An “employee” refers to a person who is hired to provide services to a company, an organization, or an individual in exchange for compensation.

A “keyword” refers to a word that is indicative of technical properties of a document. For example, a document includes a sentence “membership function is computed using fuzzy logic”, keywords associated with the document may include “fuzzy logic”. In an embodiment, the keywords may indicate skills of an employee.

A “topic” refers to a matter/subject of interest to the employee. In an embodiment, the topic may include one or more keywords indicative of properties of the topic. For example, the topic “probability” may include keywords such as, but not limited to, likelihood, density, Gaussian, estimation, distribution, and log.

A “publication” refers to issuing of a book, a journal, a computer code, an e-mail, or other work that is indicative of work done by an employee.

A “source” refers to a location from where one or more publications may be accessed or extracted. In an embodiment, some examples of the source include, but not limited to, “private source”, “protected source”, and “public source”.

A “public source” refers to sources from which one or more publications may be accessed freely (i.e., any person outside the organization may access the one or more publications). Some examples of the public sources include, but are not limited to, IEEE, ACM, Scirus, and the like.

A “protected source” refers to sources that include publications that can be accessed only by the employees of the organization. In an embodiment, no one outside the organization can access such publications. In an embodiment, the “protected source” may include documentation of the computer code used by an employee to complete a task. Further, protected source may include documentation of the tools (e.g., MATLAB, PSPICE, etc.) used by the employee to complete the task.

A “private source” refers to sources that include publications that are and exclusive to an employee of the organization. For example, e-mails and the IM messages are exclusive to the employee and can only be accessed by the concerned employee.

A “dirichlet prior” refers to a multinomial distribution of an uncertain quantity that would express one's uncertainty about the quantity before the “data” associated with the quantity is taken into account.

FIG. 1 is a block diagram illustrating a system environment 100 in which various embodiments can be implemented. The system environment 100 includes a data mining server 102, a database server 104, a network 106, and a computing device 110.

The data mining server 102 accesses one or more publications associated with an employee from one or more sources. The data mining server 102 extracts a plurality of keywords from each of the one or more publications. Further, the data mining server 102 extracts a list of topics from the database server 104. Thereafter, the data mining server 102 determines a first likelihood that at least one keyword from the plurality of keywords is relevant to a topic from the list of topics. In an embodiment, the data mining server 102 determines the first likelihood for each of the plurality of keywords. Additionally, the data mining server 102 determines a second likelihood of the employee being associated with the topic for at least one source from the one or more sources. Based on the first likelihood and the second likelihood, the data mining server 102 assigns a first set of keywords from the plurality of keywords to the employee. In an embodiment, the first set of keywords is indicative of the skills of the employee. The data mining server 102 utilizes one or more statistical techniques such as, but is not limited to, probability distribution, Bayesian, and dirichlet distribution to determine the skills of the employee.

The database server 104 is configured to store the one or more publications associated with the employee. In an embodiment, the one or more publications are pre-classified based on the source from which the publication has been obtained. In an embodiment, the database server 104 maintains folders 108 for each of the one or more sources. In an embodiment, the folders 108 include a folder for the publications extracted from a public source (depicted by 112), a folder for the publications extracted from a protected source (depicted by 114), and a folder for the publications extracted from a private source (depicted by 116). In an embodiment, the database server 104 may receive a query from the data mining server 102 and/or the computing device 110 to extract the one or more publications. The database server 104 may be realized through various technologies, such as, but not limited to, Microsoft® SQL server, Oracle, and My SQL. In an embodiment, the computing device 110 and the data mining server 102 may connect to the database server 104 using one or more protocols such as, but not limited to, ODBC protocol and JDBC protocol.

A person having ordinary skills in the art would understand that the public source, the private source, and the protected source have been mentioned for illustrative purposes. In an embodiment, the publications can be extracted from sources other than the public source, the private source, and the protected source. Further, the person skilled in the art would understand that the folders 108 in the database server 104 have been mentioned for illustrative purposes. In an embodiment, the folders 108 may reside in the data mining server 102 and/or the computing device 110.

The network 106 corresponds to a medium through which content and messages flow between various devices of the system environment 100 (e.g., the computing device 110, database server 104, and the data mining server 102). Examples of the network 106 may include, but are not limited to, a Wireless Fidelity (Wi-Fi) network, a Wireless Area Network (WAN), a Local Area Network (LAN) or a Metropolitan Area Network (MAN). Various devices in the system environment 100 can connect to the network 106 in accordance with the various wired and wireless communication protocols such as Transmission Control Protocol and Internet Protocol (TCP/IP), User Datagram Protocol (UDP), and 2G, 3G, or 4G communication protocols.

The computing device 110 presents a user interface to a user of the computing device 110. In an embodiment, the user interface is a web interface facilitated by the data mining server 102. The computing device 110 receives a user input corresponding to the location of the folders 108 in the database server 104. Some of the examples of the computing device 110 include a personal computer, a laptop, a PDA, a mobile device, a tablet, or any device that has the capability to receive and process images.

FIG. 2 is a block diagram of a system 200 for determining skills of the employee, in accordance with at least one embodiment. The system 200 is described in conjunction with FIG. 1.

The system 200 includes a processor 202, a transceiver 206, and a memory 208. In an embodiment, the system 200 may correspond to the computing device 110 or the data mining server 102. For the purpose of ongoing description, the system 200 is considered as the data mining server 102. However, the scope of the disclosure should not be limited to the system 200 as the data mining server 102. The system 200 can also be realized as the computing device 110.

The processor 202 is coupled to the input device 204, the transceiver 206, and the memory 208. The processor 202 executes a set of instructions stored in the memory 208. The processor 202 can be realized through a number of processor technologies known in the art. Examples of the processor 202 may include, but are not limited to, X86 processor, RISC processor, ASIC processor, CISC processor, ARM processor, or any other processor.

In an embodiment, the input device 204 receives an input from a user of the system 200. In an embodiment, a user input may correspond to the locations of the folders 108 in the database server 104. Examples of the input device 204 include, but are not limited to, a mouse, a keyboard, a touch panel, a track-pad, a touch screen, or any other device that has the capability of receiving the user input.

The transceiver 206 transmits and receives messages and data to/from various components of the system environment 100 (e.g., the data mining server 102 and the database server 104). Examples of the transceiver 206 may include, but are not limited to, an antenna, an Ethernet port, a USB port or any other port that can be configured to receive and transmit data. The transceiver 206 transmits and receives data/messages in accordance with the various communication protocols, such as, TCP/IP, UDP, and 2G, 3G, or 4G communication protocols.

The memory 208 stores a set of instructions and data. Some of the commonly known memory implementations include, but are not limited to, a random access memory (RAM), a read only memory (ROM), a hard disk drive (HDD), and a secure digital (SD) card. Further, the memory 208 includes a program module 210 and a program data 212. The program module 210 includes a set of instructions that is executable by the processor 202 to perform specific operations. The program module 210 further includes a user interface manager 214, a communication manager 216, a publication manager 218, a keyword extraction module 220, a probability determination module 222, and a skills determination module 224. It is apparent to a person having ordinary skills in the art that the set of instructions stored in the memory 208 enables the hardware of the system 200 to perform the predetermined operation.

The program data 212 includes a source data 226, a skill data 228, a publication data 230, a keyword data 232, a probability data 234, and a topic data 236.

The user interface manager 214 receives a user input indicative of the location of the folders 108 containing the one or more publications in the database server 104. In an embodiment, the user interface manager 214 receives the user input through the input device 204. The user interface manager 214 displays a web interface (not shown) to the user. In an embodiment, the user interface manager 214 may utilize one or more techniques such as, but are not limited to, HTML, JavaScript, and php to construct the web interface. The user interface manager 214 stores the location of the folders 108 as the source data 226. In an embodiment, the user interface manager 214 includes a driver to operate the input device 204.

The communication manager 216 transmits the web interface to the computing device 110 through the transceiver 206. In an embodiment, the communication manager 216 receives the user input through the web interface. The communication manager 216 includes various protocol stacks such as, but not limited to, TCP/IP, UDP, and 2G, 3G, or 4G communication protocols. The communication manager 216 transmits and receives the messages/data (e.g., images) through the transceiver 206 in accordance with such protocol stacks.

The publication manager 218 accesses the one or more publications associated with the employee from the folders 108 (indicative of one or more sources) mentioned by the user. In an embodiment, the publication manager 218 determines the location of the folders 108 from the source data 226. The publication manager 218 utilizes one or more querying languages such as, but is not limited to, to SQL, QUEL, CQL, and XQuery to access the one or more publications. The publication manager 218 stores the one or more publications as the publication data 230.

The keyword extraction module 220 extracts the one or more publications (accessed from the folders 108 in the database server 104) from the publication data 230. The keyword extraction module 220 extracts a plurality of keywords from each of the one or more publications using one or more parsing techniques. Some examples of parsing techniques may include, but not limited to, top-down parser, bottom-up parser, LL parser, recursive-decent parser and the like. In an embodiment, the keyword extraction module 220 utilizes Keyword Extraction Algorithm (KEA) to extract the plurality of keywords. The keyword extraction module 220 stores the plurality of keywords as the keyword data 232.

The probability determination module 222 extracts a predetermined set of topics from the topic data 236. Further, the probability determination module 222 extracts the plurality of keywords from the keyword data 232. For each keyword in the plurality of keywords, the probability determination module 222 determines a first likelihood that a keyword is relevant to a topic from the predetermined set of topics. Further, the probability determination module 222 determines a second likelihood of the employee (associated with the one or more publications from which the keyword has been extracted) being associated with the topic for at least one source from the one or more sources. In an embodiment, the at least one source is determined based on the source of the publication from which the keyword has been extracted. The determination of the first likelihood and the second likelihood has been described later in conjunction with FIG. 3. In an embodiment, the probability determination module 222 utilizes one or more techniques such as, but is not limited to, bayes theorem, Author-topic distribution, probability distribution functions, and dirichlet distribution to determine the first likelihood and the second likelihood. The probability determination module 222 stores the first likelihood and the second likelihood as the probability data 234.

The skills determination module 224 extracts the first likelihood and the second likelihood from the probability data 234. Based on the first likelihood and the second likelihood, the skills determination module 224 assigns a first set of keywords from the plurality of keywords to the employee. The assigning of the first set of keywords is described later in conjunction with FIG. 3.

FIG. 3 is a flowchart 300 illustrating a method for determining skills of an employee, in accordance with at least one embodiment. The flowchart 300 is described in conjunction with FIG. 1 and FIG. 2.

At step 302, an employee from the plurality of employees is selected. In an embodiment, the probability determination module 222 selects the employee from the plurality of employees. For example, an organization has ‘n’ number of employees, the probability determination module 222 selects employee ‘eᵢ’ where T varies from 1 to n.

In an embodiment, the communication manager 216 facilitates a web interface to a computing device 110 of the selected employee. The selected employee provides the location of the folders 108 (containing the one or more publications associated with the selected employee) in the database server 104. In an alternate embodiment, the location of the folders 108 is pre-stored in the source data 226. In an embodiment, each folder in the folders 108 is indicative of the source from which the publications (in the each folder) have been extracted. For example, the public folder 112 in the folders 108 includes publications obtained from the public sources.

At step 304, a source from the one or more sources (disclosed by the selected employee) is selected. In an embodiment, the probability determination module 222 selects the source. For example, the employee ‘eᵢ’ has disclosed x number of sources, the probability determination module 222 selects a source ‘sⱼ’ where j varies from 1 to x.

At step 306, a topic is selected from the predetermined set of topics for the selected employee and the selected source. In an embodiment, the probability determination module 222 selects the topic.

At step 308, the one or more publications are extracted from the location of the selected source. In an embodiment, the publication manager 218 extracts the one or more publications. The publication manager 218 determines the location of the folder that contains the one or more publications obtained from the selected source. For example, the probability determination module 222 selects the “public” source for the selected employee. The publication manager 218 determines the location of the “public” folder (depicted by 112) in the database server 104 from the source data 226. Thereafter, the publication manager 218 extracts the one or more publications from the “public” folder (depicted by 112). In an embodiment, the publication manager 218 utilizes one or more querying languages to extract the one or more publications from the database server 104.

At step 310, the plurality of keywords is extracted from each of the one or more publications. In an embodiment, the keyword extraction module 220 extracts the plurality of keywords. The keyword extraction module 220 parses each of the one or more publications to extract the plurality of keywords. In an embodiment, while parsing, the keyword extraction module 220 ignores articles (e.g., a, an, and the), connector terms (e.g., and, when, etc.), etc. in the publication. For example, a publication includes a sentence “The rate of flow of reactants is controlled by a PID controller”. The keyword extraction module 220 would parse the sentence in the publication to extract the keywords “rate”, “flow”, “reactants”, “controlled”, and “PID controller”. The keyword extraction module 220 stored the plurality of keywords as the keyword data 232.

At step 312, a first count is determined. In an embodiment, the first count corresponds to the instances in which a keyword from the plurality of keywords has been assigned to the selected topic (determined in step 306) before the current instance. In an embodiment, the probability determination module 222 determines the first count. For example, if the term “PID controller” has been assigned to the topic “control engineering” 115 (one hundred fifteen) times before this instance, 115 (one hundred fifteen) is the first count.

At step 314, the first likelihood of the keyword is determined based on the first count. In an embodiment, the probability determination module 222 determines the first likelihood. In an embodiment, the first likelihood corresponds to a probability that the keyword is relevant to the selected topic. In order to compute the first likelihood, the probability determination module 222 assigns a first dirichlet prior (β) to the first likelihood. In an embodiment, the first dirichlet prior is a probability of the first likelihood. In an embodiment, following equation may be utilized to determine the first probability/likelihood:

$${φ}_{w , u} = \frac{{M}_{wu}^{KT} + β}{{\sum }_{{w}^{′}} {M}_{{w}^{′} u}^{KT} + K β} \qquad Equation ( 1 )$$

where,

_{w,u}: First likelihood that keyword w is assigned to topic u;

K: Number of unique keywords;

T: Number of topics;

M_{wu}^{KT}: First count of the instances where the keyword w has been previously assigned to topic u;

β: First dirichlet prior; and

w′: Keywords that have been assigned to topic u other than keyword w.

At step 316, a second count is determined. In an embodiment, the second count corresponds to the instances in which the selected employee is associated with the selected topic for the selected source. In an embodiment, the probability determination module 222 determines the second count. For example, if the term “employee 1” has been associated with the topic “control engineering” 20 (twenty) times for “public” source before this instance, 20 (twenty) is the second count.

At step 318, the second likelihood of the selected employee is determined based on the second count. In an embodiment, the probability determination module 222 determines the second likelihood. In an embodiment, the second likelihood corresponds to a probability that the selected employee is associated with the selected topic for the selected source. In order to compute the second likelihood, the probability determination module 222 assigns a second dirichlet prior (α) to the second likelihood. In an embodiment, the second dirichlet prior is a probability of the second likelihood. In an embodiment, following equation may be utilized to compute the second probability/likelihood:

$${θ}_{u , v , c} = \frac{{M}_{uvs}^{TES} + α}{{\sum }_{{u}^{′}} {M}_{{u}^{′} vs}^{TES} + T α} \qquad Equation ( 2 )$$

where,

θ_{u,v,c}: Second likelihood is employee v being associated to topic u for the source c;

Mᵤᵥₛ^{TES}: Second count of the instances where the employee v has been previously assigned to topic u for the source c;

E: Number of employees;

S: Number of sources;

α: Second dirichlet prior; and

u′: All topics that have been assigned to employee v other than topic u.

At step 320, the first set of keywords is assigned to the selected employee based on the first likelihood and the second likelihood. In an embodiment, the skills determination module 224 assigns the first set of keywords. The skills determination module 224 determines the likelihood of each of the plurality of keywords being assigned to the selected employee and the selected topic. In an embodiment, following equation may be utilized to determine the likelihood:

P(zᵢ=u,xᵢ=v|kᵢ=w,z₋ᵢ,x₋ᵢ)∝θ_{u,v,c}·_{w,u} Equation (3)

where,

P(zᵢ=u,xᵢ=v|kᵢ=w,z₋ᵢ,x₋ᵢ): Likelihood that i^{th} keyword in the publication is assigned to employee v and topic u;

z₋ᵢ: Topics that do not include the i^{th} keyword; and

x₋ᵢ: Employees that have not been assigned to i^{th} keyword.

The skills determination module 224 determines the probability for each of the plurality of keywords extracted from the one or more publications from the selected source. Based on the probability, the first set of keywords is assigned to the selected topic and the selected employee for the selected source.

Steps 304-320 are repeated for each source in which the selected employee has publications.

Steps 302-320 are repeated for each employee in the organization.

For example, an organization has 100 employees out of which skills of “employee-1” have to be determined. Employee-1 has two publications published in the public source, three publications in the protected source, and one publication in the private source. Let predetermined set of topic include topics namely “control engineering”, “tools”, and “probability”.

Firstly, the publication manager 218 extracts the two publications from the public source (as described in step 308). For each of the two publications, the keyword extraction module 220 extracts a plurality of keywords (as described in step 310). For instance, the plurality of keywords includes terms such as “fuzzy”, “PID controller”, and “probability distribution function”.

For each of the plurality of keywords (i.e., “fuzzy”, “PID controller”, and “probability distribution function”), a first count of instances in which the keyword (e.g., fuzzy) has been assigned to the selected topic (e.g., control engineering). Let the total number of previous occurrences of keyword “fuzzy” in “control engineering” is 20. Based on the first count, the probability determination module 222 computes the first likelihood. Let the first likelihood for the keyword “fuzzy” be assigned to topic “control engineering” is 0.7. Similarly, the first likelihood is determined for each of the plurality of keywords (i.e., “PID controller”, and “probability distribution function”) for the topic “control engineering”. Let the first likelihood for term “PID controller” and “probability distribution function” for the topic “control engineering” is 0.6 and 0.3, respectively. Based on the first likelihood, the terms “PID controller” and “fuzzy” are assigned to the topic “control engineering”.

The probability determination module 222 determines a second likelihood of the employee being associated with topics “control engineering” “tools”, and “probability” for the “public source”. Let the second likelihood for topics “control engineering” “tools”, and “probability” be 0.7, 0.2, and 0.9, respectively. The employee-1 will be assigned to the topics “control engineering” and “probability”. In an embodiment, the second likelihood varies based on the source from which the one or more publications have been extracted.

For example, the publication manager 218 extracts the one or more publications from the “protected” source. In an embodiment, the one or more publications from the “protected” source include publications corresponding to the documentation of a computer program code that the “employee-1” has written to accomplish a task. Thus, the one or more publications from the “protected” source will be more related to tools that the “employee-1” has used to accomplish the task. Thus, the probability that “employee-1” is assigned to topic “tools” will be high for the “protected” source in comparison to the topics “control engineering” and “probability”.

Based on the first likelihood and the second likelihood, a set of keywords is assigned to the employee-1 that is indicative of the skills of the employee. For instance, keyword “PID controller” is assigned to “employee-1”.

In an embodiment, keywords assigned to the employee for the publications extracted from the public source are indicative of research skills of the employee. Similarly, keywords assigned to the employee for the publications extracted from the protected source are indicative of the engineering skills of the employee. Keywords assigned to the employee for the publications extracted from the private source are indicative of the managerial skills of the employee.

FIG. 4 is a table 400 illustrating sample skills of an employee, in accordance with at least one embodiment.

The table 400 includes a column 402 titled “Name of employee”. For example, the column 402 includes names such as “employee-1” (depicted by 408). Further, the table 400 includes a column 404 titled “Source”. The column 404 illustrates various sources from which the one or more publications have been extracted for the employee. For example, for “employee-1” (depicted by 408), the one or more publications have been extracted from “public” source (depicted by 410), “protected” source (depicted by 414), and “private” source (depicted by 418). The table 400 further includes a column 406 titled “Skills”. The column 406 illustrates the skills of the employee for the at least one source from the sources listed in the column 404. For example, the “employee-1” (depicted by 408) has “video processing” skills (depicted by 412) for the “public” source (depicted by 410). Similarly, the “employee-1” (depicted by 408) has “C/C++” programming skills (depicted by 416) for the “protected” source (depicted by 414). Further, the “employee-1” (depicted by 408) has “managerial” skills (depicted by 420) for the “private” source (depicted by 418).

The disclosed embodiments encompass numerous advantages. The skills of an employee are determined based on the publications associated with the employee. The publications are extracted from various sources used by the employee to publish his/her work. In an embodiment, the various sources are deterministic of the type of skill that the employee possesses. For example, the employee has published a paper on IEEE, which is an example of a “public” source. The paper is indicative of the research skills of the employee. Thus, keywords (indicative of the skills) assigned to the employee from the publication from the public source is indicative of research skills. Similarly, the publications from the other sources may indicate different type of skills. This classification of the skills (based on the sources) gives a detailed picture of the areas of strength and improvement for the employee.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in all operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for determining skills of an employee have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method implementable on a computing device for determining skills of an employee, the method comprising:
determining a first likelihood of at least one keyword from a plurality of keywords being relevant to a topic, wherein the plurality of keywords are extractable from one or more publications associated with the employee, the one or more publications being accessible from a plurality of sources;
determining a second likelihood of the employee being associated with the topic for at least one source from the plurality of sources; and
assigning a first set of keywords from the plurality of keywords to the employee based on the first likelihood and the second likelihood, wherein the first set of keywords is indicative of the skills of the employee.

2. The method of claim 1 further comprising determining a first count of instances of the at least one keyword being assigned to the topic, wherein the first likelihood is determined based on the first count.

3. The method of claim 1, wherein the first likelihood is determined based on a first dirichlet prior, wherein the first dirichlet prior is indicative of a probability of the first likelihood.

4. The method of claim 1 further comprising determining a second count of instances of the employee being associated with the topic for the at least one source, wherein the second likelihood is determined based on the second count.

5. The method of claim 1, wherein the second likelihood is determined based on a second dirichlet prior, wherein the second dirichlet prior is indicative of a probability of the second likelihood.

6. The method of claim 1, wherein the plurality of sources comprises a public source, a protected source, a private source, or combinations thereof.

7. A data mining server for determining skills of an employee, the data mining server comprising:
a keyword extractor configured to extract a plurality of keywords from one or more publications associated with the employee, wherein the one or more publications are accessible from a plurality of sources;
a probability determination module configured to:
determine a first likelihood of at least one keyword from the plurality of keywords being relevant to a topic; and
determine a second likelihood of the employee being associated with the topic for at least one source from the plurality of sources; and
a skills determination module configured to assign a first set of keywords from the plurality of keywords to the employee based on the first likelihood and the second likelihood, wherein the first set of keywords is indicative of the skills of the employee.

8. The data mining server of claim 7 further comprising a user interface manager configured to receive a user input indicative of location of the plurality of sources.

9. The data mining server of claim 8 further comprising a publication manager configured to access the one or more publications of the employee from the location of the plurality of sources.

10. The data mining server of claim 7, wherein the probability determination module is further configured to determine a first count of instances of at least one keyword being assigned to the topic, wherein the first likelihood is determined based on the first count.

11. The data mining server of claim 7, wherein the probability determination module is further configured to determine a second count of instances of the employee being associated with the topic for the at least one source, wherein the second likelihood is determined based on the second count.

12. The data mining server of claim 7, wherein the plurality of sources comprises a public source, a protected source, a private source, or combinations thereof.

13. The data mining server of claim 12, wherein the first set of keywords for the public source is indicative of research skills of the employee.

14. The data mining server of claim 12, wherein the first set of keywords selected for the protected source is indicative of engineering or technical skills of the employee.

15. The data mining server of claim 12, wherein the first set of keywords selected for the private source is indicative of at least one of managerial skills or communication skills of the employee.

16. A computer program product for determining skills of an employee, the computer program product comprising a set of instructions executable by a processor, the set of instructions comprising:
program instruction means for extracting a plurality of keywords from one or more publications associated with the employee, wherein the one or more publications are accessible from a plurality of sources;
program instruction means for determining a first likelihood of at least one keyword from the plurality of keywords being relevant to a topic;
program instruction means for determining a second likelihood of the employee being associated with the topic for at least one source from the plurality of sources; and
program instruction means for assigning a first set of keywords from the plurality of keywords to the employee based on the first likelihood and the second likelihood, wherein the first set of keywords is indicative of the skills of the employee.

17. The computer program product of claim 16, wherein the first likelihood is determined based on a first dirichlet prior, wherein the first dirichlet prior is indicative of a probability of the first likelihood.

18. The computer program product of claim 16, wherein the second likelihood is determined based on a second dirichlet prior, wherein the second dirichlet prior is indicative of a probability of the second likelihood.

19. The computer program product of claim 16 further comprising a program instruction means for determining a first count of instances of the at least one keyword being assigned to the topic, wherein the first likelihood is determined based on the first count.

20. The computer program product of claim 16 further comprising a program instruction means determining a second count of instances of the employee being associated with the topic for the at least one source, wherein the second likelihood is determined based on the second count.
